(19) United States
(12) Patent Application Publication
(10) Pub. No.: US 2014/0026210 A1
(43) Pub. Date: Jan. 23, 2014

(54) METHOD FOR AUTHENTICATING MOBILE DEVICES

(71) Applicant: Electronics and Telecommunications Research Institute, Daejeon (KR)

(72) Inventors: Bo-Heung CHUNG, Daejeon (KR); Jin Hee HAN, Daejeon (KR); Yong Hyuk MOON, Daejeon (KR); HWA SHIN MOON, Daejeon (KR); Jeong Nyeo KIM, Daejeon (KR)

(21) Appl. No.: 13/944,754

(22) Filed: Jul. 17, 2013

(30) Foreign Application Priority Data
Jul. 23, 2012 (KR) 10-2012-0080115
Jul. 2, 2013 (KR) 10-2013-0076907

(51) Int. Cl. H04W 12/06

(52) U.S. Cl. CPC H04W 12/06
USPC 726/17

(57) ABSTRACT

A method for authenticating a mobile device, the method comprising: detecting an external input to the mobile device; when the external input is detected, displaying a screen lock pattern having at least two or more pattern points, each pattern point having an identifier; determining whether a touch input is conducted on the at least two or more pattern points in an UI (User Interface) locked state of the mobile device; and when the touch input conducted on the at least two or more pattern points is successively made in a preset sequenced combination of identifiers, unlocking the locked state of the mobile device.

### RELATED APPLICATIONS

This application claims the benefit of Korean Patent Application No. 10-2012-0080115, filed on Jul. 23, 2012, and Korean Patent Application No. 10-2013-0076907, filed on Jul. 2, 2013, which is hereby incorporated by reference as if fully set forth herein.

### FIELD OF THE INVENTION

The present invention relates to an authentication technology for mobile devices, and more particularly, to a method for authenticating mobile devices capable of maintaining a security of drawing patterns used in an authentication process of a screen lock pattern for the mobile devices such as smart phones, smart pads, tablet PCs or the like.

### BACKGROUND OF THE INVENTION

In recent years, the spread of mobile handheld devices such as smart phones, smart pads, tablet PCs and the like have increased rapidly, and these devices are used in homes as well as public places such as subways, schools, theaters and the like. In the case of locking or unlocking a mobile device, performing a user authentication for the use of applications, or performing financial transactions, a password authentication in the form of a drawing pattern is mainly used when using the mobile device in public places. The password of a pattern shape facilitates a convenient usage because of easy to remember, but there is a possibility that the risk of unwanted exposure occurs when entering the pattern.

Accordingly, measures for guarding safely the drawing pattern are required to provide for such a case. In other words, it is necessary that a malicious user is not allowed to use this device even if the drawing pattern is exposed easily to the outside during the input of the drawing pattern.

A password method in the shape of the drawing pattern is a method of performing a user authentication by touching (inputting or drawing) a specific pattern on a touch screen. It has a limit for the following reasons:

1) The drawing pattern to be input is highly likely to be exposed easily around. In other words, the drawing pattern can be easily peeped over around (just next to, behind) a user in public places if it is inputted in those places. When the drawing pattern is exposed in this manner, an unauthorized use can be made easily. Thus, a method that does not expose the drawing pattern when inputting the pattern is required.

2) Frequent change in the drawing pattern may reduce the risk described above. That is, the drawing pattern may be changed after use in the public places, or it is possible to change the drawing pattern every period, which is relatively short, such as every morning/night or day. However, it leads to a burden that a user must remember so many patterns. Further, an excessive frequent change in the drawing pattern is likely to cause a situation where a user does not remember the drawing pattern.

Therefore, there is a need to provide a method that can reduce the risk as described above, without changing the drawing pattern frequently.

### SUMMARY OF THE INVENTION

In view of the above, the present invention provides a method for authenticating a mobile device, which is capable of preventing the exposure of a drawing pattern, which is a screen lock pattern and disabling a user authentication using the exposed drawing pattern even though the drawing pattern is exposed when using the drawing pattern in a user authentication process of the mobile device.

In accordance with an embodiment of the present invention, there is provided a method for authenticating a mobile device, which includes: detecting an external input to the mobile device; when the external input is detected, displaying a screen lock pattern having at least two or more pattern points, each pattern point having an identifier; determining whether a touch input is conducted on the at least two or more pattern points in an UI (User Interface) locked state of the mobile device; and when the touch input conducted on the at least two or more pattern points is successively made in a preset sequenced combination of identifiers, unlocking the locked state of the mobile device.

In the exemplary embodiment, wherein the external input to the mobile device comprises a key input signal to the mobile device.

In the exemplary embodiment, wherein the identifier comprises either a number or a character.

In the exemplary embodiment, wherein the at least two or more pattern points comprises any one of a circle, an ellipse or a polygon in a shape.

In the exemplary embodiment, wherein the at least two or more pattern points changes randomly in their positions.

In the exemplary embodiment, wherein the screen lock pattern comprises the at least two or more pattern points that are arranged in the form of a matrix.

In the exemplary embodiment, wherein the preset sequenced combination of identifiers comprises sequenced identifiers in which at least two or more identifiers are combined.

In the exemplary embodiment, wherein the preset sequenced combination of identifiers comprises sequenced identifiers in which at least two or more identifiers are arranged in a random order.

In the exemplary embodiment, the method further comprising: when the touch input conducted on the at least two or more pattern points is failing to match a preset sequenced combination of identifiers, maintaining the locked state of the mobile device.

In accordance with an embodiment of the present invention, when using a screen lock pattern (drawing pattern) in a user authentication process for the mobile device, the drawing pattern is prevented from exposing, and the drawing pattern acquired by an unauthorized user does not pass a user authentication even if the drawing pattern is exposed. Therefore, because the embodiment of the present invention offers an authentication technology to generate pattern points (points in the form of a circle that are represented in advance for drawing a pattern on a screen) that are displayed by numbers on a screen lock pattern of the mobile device, and develops and provides it as a separate plug-in module for an administrative task or provides it through a minor change of an existing authentication module, it is possible to interact easily with the process of an existing user authentication for the mobile device. Further, since the authentication technology in accordance with the present invention has a configuration which can be applied easily to the format of hardware, it is possible to develop the authentication technology in the form of TPM (Trusted Platform Module) or a secure USB (Universal Serial Bus), thereby improving the safety of the password easily and conveniently. In other words, when a technique that creates and manages a location and information value of the pattern recognition points having the identifiers is manufactured in the form of hardware such as TPM, MTM (Mobile Trusted Module) or the like or is made to be included in such hardware, critical information can be safely stored so as not to be taken easily.

### BRIEF DESCRIPTION OF THE DRAWINGS

The above and other objects and features of the present invention will become apparent from the following description of the embodiments given in conjunction with the accompanying drawings, in which:

FIG. 1 is a schematic block diagram of a mobile device for implementing an authentication method for the mobile device in accordance with an embodiment of the present invention;

FIG. 2 is a flow diagram illustrating an authentication method performed in a mobile device in accordance with an embodiment of the present invention; and

FIGS. 3 and 4 show an unlocking process of a screen lock pattern of the authentication method for the mobile device in accordance with an embodiment of the present invention.

### DETAILED DESCRIPTION OF THE EMBODIMENTS

The advantages and features of exemplary embodiments of the present invention and methods of accomplishing them will be clearly understood from the following description of the embodiments taken in conjunction with the accompanying drawings. However, the present invention is not limited to those embodiments and may be implemented in various forms. It should be noted that the embodiments are provided to make a full disclosure and also to allow those skilled in the art to know the full scope of the present invention. Therefore, the present invention will be defined only by the scope of the appended claims.

In the following description, well-known functions or constitutions will not be described in detail if they would unnecessarily obscure the embodiments of the invention. Further, the terminologies to be described below are defined in consideration of functions in the invention and may vary depending on a user's or operator's intention or practice. Accordingly, the definition may be made on a basis of the content throughout the specification.

The combinations of the each block of the block diagram and each operation of the flow chart may be performed by computer program instructions. Because the computer program instructions may be loaded on a general purpose computer, a special purpose computer, or a processor of programmable data processing equipment, the instructions performed through the computer or the processor of the programmable data processing equipment may generate the means performing functions described in the each block of the block diagram and each operation of the flow chart. Because the computer program instructions may be stored in a computer usable memory or computer readable memory which is capable of intending to a computer or other programmable data processing equipment in order to embody a function in a specific way, the instructions stored in the computer usable memory or computer readable memory may produce a manufactured item involving the instruction means performing functions described in the each block of the block diagram and each operation of the flow chart. Because the computer program instructions may be loaded on the computer or other programmable data processing equipment, the instructions performed by the computer or programmable data processing equipment may provide the operations for executing the functions described in the each block of the block diagram and each operation of the flow chart by a series of functional operations being performed on the computer or programmable data processing equipment, thereby a process executed by a computer being generated.

Moreover, the respective blocks or the respective sequences may indicate modules, segments, or some of codes including at least one executable instruction for executing a specific logical function(s). In several alternative embodiments, it is noticed that the functions described in the blocks or the sequences may run out of order. For example, two successive blocks and sequences may be substantially executed simultaneously or often in reverse order according to corresponding functions.

Before describing the present invention, it is noted that the present invention offers a technique for preventing and protecting a screen lock pattern from an exposure when performing a password authentication process for mobile devices, whereby the object of the present invention will be achieved readily from the technical idea.

Hereinafter, the embodiments of the present invention will be described in detail with reference to the accompanying drawings.

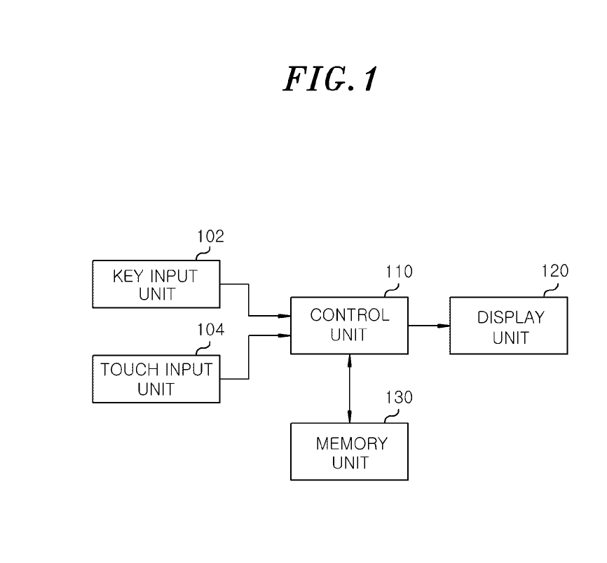

FIG. 1 is a schematic block diagram of a mobile device, for example, a smart phone, a smart pad, a tablet PC and the like for implementing an authentication method in accordance with an embodiment of the present invention. The mobile device includes a key input unit 102, a touch input unit 104, a control unit 110, a display unit 120 and a memory unit 130.

As illustrated in FIG. 1, the key input unit 102 is responsible for receiving key input signals such as signals generated from a power key, a volume up/down key and the like to deliver them to the control unit 110.

The touch input unit 104 may be, for example, a touch screen or the like and senses a touch input signal corresponding to a haptic contact and/or a tactile contact. Such a touch input unit 104 may include a touch sensitive surface which is able to sense a touch input signal.

The control unit 110 detects the touch input signal corresponding to a user's contact with the touch input unit 104 and controls any component in the mobile device depending on the detected touch input signal or controls the display unit 120 such that it can represent screen information corresponding to the detected touch input signal to the outside. Similarly, the control unit 110 controls any component in the mobile device depending on a certain key input signal or controls the display unit 120 such that it can represent screen information corresponding to the key input signal to the outside. For example, the control unit 110 controls the display unit 120 to display a screen lock pattern for the mobile device or controls the mobile device to unlock the locked state of the mobile device systemically.

The display unit 120 serves to display the screen information under the control of the control unit 110 and may include, for example, an LCD (Liquid Crystal Display), an OLED (Organic Light Emitting Diode), etc. The display unit 120 is coupled to the touch input unit 104 in the form of a module with each other, which is well known to those skilled ones in the art.

The memory unit 130 includes a plurality of applications necessary to drive the mobile device, a UI (User Interface) state module (e.g., a lock/unlock module) and the like. The memory unit 130 may include any one of a RAM (Random Access Memory), magnetic disk storage, non-volatile memories such as a flash memory, etc. and saves or optionally selects any information in accordance with a request from the control unit 110.

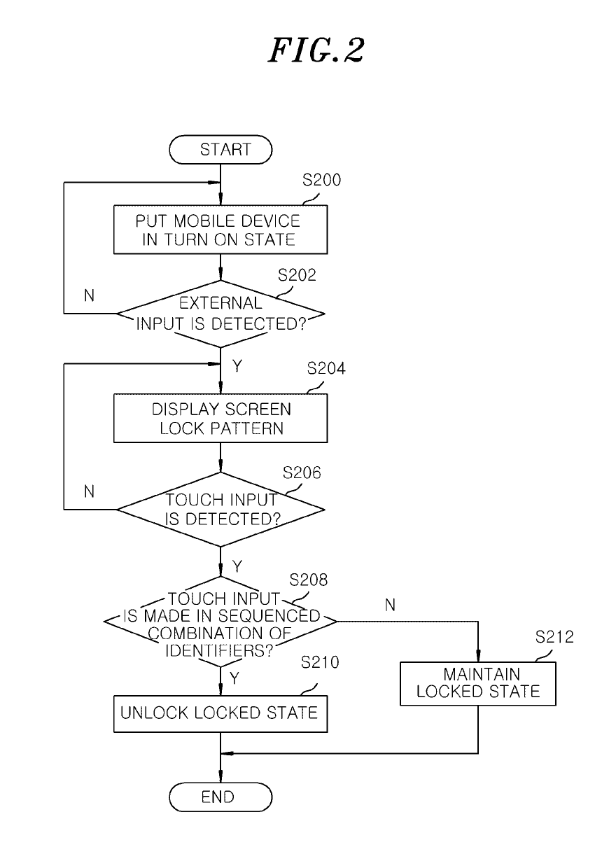

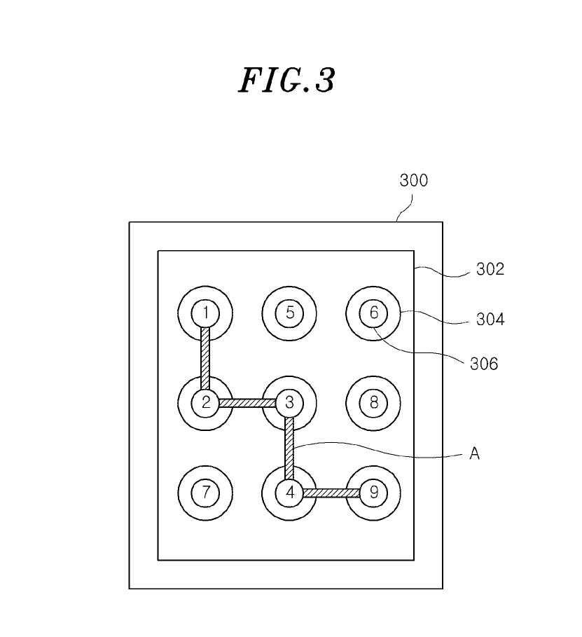

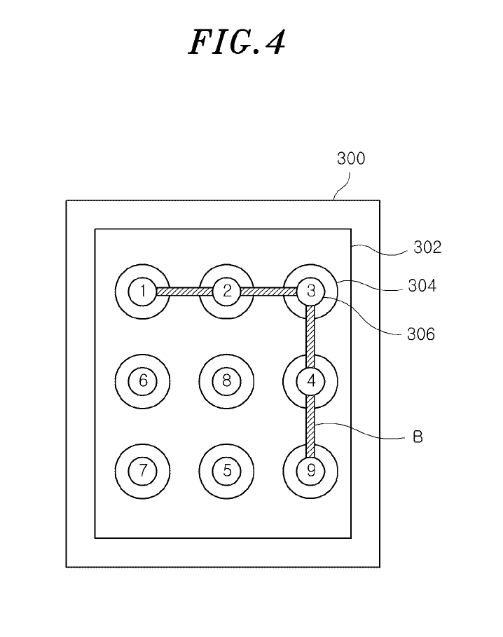

Hereinafter, an authentication method for the mobile device in accordance with an embodiment of the present invention will be described with reference to a flow diagram of FIG. 2 and illustrative drawings of FIGS. 3 and 4, along with the configuration as set forth above.

As illustrated in FIG. 2, in a state where the mobile device is turned on, in an operation S200, the control unit 110 detects whether there is an external input to the mobile device, in an operation S202. The external input may include, for example, a key input signal caused by the key input unit 102.

When it is detected that the external input is present in the operation S202, the control unit 110 controls the display unit 120 to display a screen lock pattern with identifiers in accordance with an embodiment of the present invention.

In this case, the screen lock pattern includes a plurality of (e.g., two or more) pattern points 304 displayed on a screen 300 of the mobile device, as illustrated in FIG. 3. In FIG. 3, the pattern points 304 are represented in the form of a circle, and it can be seen that a total of nine pattern points 304 is arranged in the shape of a matrix.

It is understood that the arrangement and the form of the pattern points 304 in FIG. 3 are merely an illustrative example. For example, a pattern point 304 may be exchanged with an ellipse or a polygon depending on operating environments and thus it is not necessary to confine the number of the pattern points 304 at a specific value.

Further, in accordance with an embodiment of the present invention, the pattern points 304 have different identifiers to each other, as illustrated in FIG. 3. In this case, the respective identifiers, for example, may have either numbers or characters, and the respective identifiers may be arranged to be overlapped on the pattern points 304.

A state where such a screen lock pattern is displayed represents that the UI of the mobile device is locked. In the UI locked state, the control unit 110 detects the presence of a touch input signal via the touch input unit 104, in an operation S206.

When the touch input signal is detected, the control unit 110 determines whether the touch input signal is inputted in a preset sequenced combination of identifiers, in an operation S208. Specifically, the control unit 110 detects the touch input signal provided from the touch input unit 104 and determines whether the touch input signal is an input signal corresponding to a screen lock pattern ‘A’ as illustrated in FIG. 3. In this example in FIG. 3, the screen lock pattern ‘A’ may be a drawing pattern having a combined sequence of the identifiers 1-2-3-4-9 on the pattern points 304.

If it is determined that there is a touch input corresponding to the preset sequenced combination of identifiers, the control unit 110 performs an unlocking of the locked state of the mobile device, in an operation S210.

However, if it is determined that the touch input does not correspond to the preset sequenced combination of identifiers, that is, if it is determined that the touch input is failing to match at least two or more pattern points in the preset sequenced combination of identifiers, the control unit 110 continues to maintain the locked state of the mobile device, in an operation S212.

On the other hand, in accordance with another embodiment of the present invention, it is possible to configure so that the positions of the pattern points 304 having identifiers 306 may be changed randomly whenever an external input occurs. Alternatively, it may also be possible to change the identifiers of the pattern points 304 randomly whenever an external input occurs.

For example, as shown in FIG. 4, it is noted that the same sequenced combination of identifiers 1-2-3-4-9 is maintained as in FIG. 3, but a screen lock pattern ‘B’ is different in the shape of the pattern. This is to ensure that a security maintains even though an authentication pattern is leaked to a third party when the mobile device is unlocked using the screen lock pattern, which can be achieved by allowing a screen lock pattern to be different whenever an external input occurs.

Similarly, even in a case where the identifiers have characters instead of the numbers, a sequenced combination of identifiers in which the characters may be arranged in a random order.

As set forth above, the embodiment of the present invention implements to perform an effective user authentication in a process of an authentication in the form of a drawing pattern for mobile devices. Specifically, since the drawing pattern is inputted in a specific sequence of numbers in the process of inputting a password having the drawing pattern, the same drawing pattern that had been inputted cannot pass an authentication process normally even though the drawing pattern is exposed. Therefore, it is possible to perform an authentication process safely even in an environment such as public places where it is difficult to maintain the confidentiality of the authentication process for a user. In this process, although the user is passed through the user authentication process without the need to define and use a new drawing pattern different from a previous one each time to be authenticated, it is possible to provide the same effect as if the user authentication process is performed with different drawing patterns every authentication process.

While the present invention has been shown and described with reference to specific matters such as the concrete elements and the definitive embodiments and drawings, it should be noted by those skilled in the art that these are provided only for the general understanding of the present invention. Therefore, the present invention may not be limited to the foregoing embodiments and may be changed and modified in various forms from the above description.

What is claimed is:

1. A method for authenticating a mobile device, the method comprising:
detecting an external input to the mobile device;
when the external input is detected, displaying a screen lock pattern having at least two or more pattern points, each pattern point having an identifier;
determining whether a touch input is conducted on the at least two or more pattern points in an UI (User Interface) locked state of the mobile device; and
when the touch input conducted on the at least two or more pattern points is successively made in a preset sequenced combination of identifiers, unlocking the locked state of the mobile device.

2. The method of claim 1, wherein the external input to the mobile device comprises a key input signal to the mobile device.

3. The method of claim 1, wherein the identifier comprises either a number or a character.

4. The method of claim 1, wherein the at least two or more pattern points comprises any one of a circle, an ellipse or a polygon in a shape.

5. The method of claim 1, wherein the at least two or more pattern points changes randomly in their positions.

6. The method of claim 1, wherein the screen lock pattern comprises the at least two or more pattern points that are arranged in the form of a matrix.

7. The method of claim 1, wherein the preset sequenced combination of identifiers comprises sequenced identifiers in which at least two or more identifiers are combined.

8. The method of claim 1, wherein the preset sequenced combination of identifiers comprises sequenced identifiers in which at least two or more identifiers are arranged in a random order.

9. The method of claim 1, further comprising:
when the touch input conducted on the at least two or more pattern points is failing to match a preset sequenced combination of identifiers, maintaining the locked state of the mobile device.
